(19) United States
(12) Patent Application Publication
(10) Pub. No.: US 2011/0249305 A1
(43) Pub. Date: Oct. 13, 2011

(54) IMAGE PROCESSING APPARATUS, IMAGE FORMING METHOD AND PROGRAM

(76) Inventor: Takeshi OKAMOTO, Osaka (JP)

(21) Appl. No.: 13/069,707

(22) Filed: Mar. 23, 2011

(30) Foreign Application Priority Data
Apr. 8, 2010 (JP) 2010-089597

(51) Int. Cl. H04N 1/04

(52) U.S. Cl. 358/474

(57) ABSTRACT

An image processing apparatus includes: an area separation processor that classifies image data into halftone dot areas, on-screen text areas, text areas and the other areas and outputs an area separation signal that indicates the area type of the area; and a spatial filtering processor that performs a spatial filtering process on the image data with reference to the area separation signal. The spatial filtering processor performs a different filtering process in accordance with the color space of the input image data when the area separation signal indicates that the area is an on-screen text area.

This Nonprovisional application claims priority under 35 U.S.C. §119 (a) on Patent Application No. 2010-089597 filed in Japan on 8 Apr. 2010, the entire contents of which are hereby incorporated by reference.

### BACKGROUND OF THE INVENTION

(1) Field of the Invention

The present invention relates to an image processing apparatus, image forming method and program.

(2) Description of the Prior Art

Conventionally, there has been an image processing apparatus that processes image data of a document read by an image input apparatus such as a scanner or the like. As an example to which an image processing apparatus is applied, a digital multifunctional machine can be considered. This digital multifunctional machine can realize a copying function by forming (printing) images on recording paper based on the image data from the document or can realize a scanning function (PUSH copy function) by transferring the image data to a terminal such a computer etc.

In this process, the document to be read includes various types (areas) such as text, photographs, pattern etc. In particular, photographs and patterns have been formed of tiny dots (halftone dots) at the stage of printing, and are determined as halftone dot areas also by the image processing apparatus.

This halftone dot area often ends up the cause of moiré, depending on the relationship between the dot pitch in the document and the recognizing condition of the image reader. There are also cases where moiré occurs due to the relationship between the image data and the condition of the image forming unit to output. In order to inhibit the moiré from taking place, it is preferable to use a smoothening process. Accordingly, in an image processing apparatus (digital multifunctional machine), it is possible to prevent occurrence of moiré by subjecting the image data to a smoothening process by selecting “photographic mode” or the like.

On the other hand, in order to clearly print and display an area where text is recorded, the area is preferably subjected to a sharpening process. Accordingly, it has been known in the image processing apparatus (digital multifunctional machine) that image data is subjected to a sharpening process to enhance the reproducibility of text by selecting “text mode” or the like.

However, a usual document may include both text and photographs (patterns). To deal with such a document, Patent Document 1, for example, discloses a technique in which whether an observed pixel belongs to an edge area of a character that is thinner, or belongs to an edge area of a character that is thicker, than the predetermined text size, is examined so as to perform determination of text edge areas while an area where there is a great variation in density in a small area or there is a point that is high in density compared to the background is determined to be a halftone dot area, whereby the halftone dot area is prevented from producing moiré by applying a smoothening filter while the text edge area is improved in text reproducibility by applying a sharpening filter.

### Patent Document 1:

Japanese Patent Application Laid-open 2003-224718

However, in the above Patent Document 1, there is no consideration on whether the output image data is that used for printing or that used for display (image data). Detailedly, since the cause of creating moiré as a result of image data used in the copying function and the cause of moiré as a result of image data used in the scanner function are different, there occurs such a problem that the image data that has been processed and suited for printing is effective in the copying function, but the data can not create a sharp image when it is used as the result of a scanner function (image data for display).

In particular, when text is included in a halftone dot area (that is, when text is superimposed on a halftone screen), if the area is simply smoothened, the part becomes blurred as a whole. This will not cause any problem in the copying function, but causes a problem, i.e., poor reproduction of text when the image data is used as the result of a scanner function.

Further, if the whole data is subjected to a sharpening process, text reproducibility is improved hence favorable result can be obtained when the image data is used as the result of a scanner function. On the other hand, when the image data is used in the copying (printing) function, there occurs the problem that moiré takes place in the halftone screen under the text.

### SUMMARY OF THE INVENTION

It is therefore an object of the present invention to provide an image processing apparatus and the like which can improve reproducibility of text on a halftone screen and can output the halftone dot area optimally both when an image is output as a printout and when an image is output as image data for display.

In view of the problems described above, the image processing apparatus of the present invention includes:

an area separation processor that classifies image data into halftone dot areas, on-screen text areas, text areas and the other areas and outputs an area separation signal that indicates the area type of the area; and,

a spatial filtering processor that performs a spatial filtering process on the image data with reference to the area separation signal, and is characterized in that

the spatial filtering processor performs a different filtering process in accordance with the color space of the input image data when the area separation signal indicates that the area is an on-screen text area.

The image processing apparatus of the present invention is further characterized in that the area separation processor, includes:

an on-screen text area determinator which, when a target area is detected as a halftone dot area, determines whether the area includes a text; and,

a text edge determinator that determines whether the text edge is detected from the target area, and,

performs a process of outputting an area separation signal that indicates a halftone dot area or an on-screen text area, based on the result of determination at the on-screen text area determinator and the result of determination at the text edge determinator.

Also, the image processing apparatus of the present invention is characterized in that, when the on-screen text area determinator determines that the target area includes the text and the text edge determinator detects the text edge, the area separation processor determines that the target area is a first on-screen text area,

when the on-screen text area determinator determines that the target area includes no text and the text edge determinator detects the text edge, the area separation processor determines that the target area is a second on-screen text area, and,

the spatial filtering processor performs a different filtering process in accordance with the color space of the input image data when the area separation signal indicates that the target area is the second on-screen text area.

An image forming apparatus of the present invention includes:

an image input device that captures image data;

an image processor that processes the input image data; and

an image forming portion that forms an image from the image data that has been processed by the image processor, and is characterized in that the image processor is the image processing apparatus of the invention described above.

An image processing method of the present invention includes the steps of:

classifying image data into halftone dot areas, on-screen text areas, text areas and the other areas; and,

performing a spatial filtering process on each of the classified areas, and is characterized in that the spatial filtering process is implemented to perform a different filtering process in accordance with the color space of the input image data when the classified area is an on-screen text area.

The program of the present invention resides in a program that causes a computer to execute:

a step of classifying image data into halftone dot areas, on-screen text areas, text areas and the other areas;

a step of area separation processing for outputting an area separation signal that indicates the area type of the area;

a step of performing a spatial filtering process on the image data with reference to the area separation signal, and is characterized in that the step of spatial filtering process is implemented to perform a different filtering process in accordance with the color space of the input image data when the area separation signal indicates that the area is an on-screen text area.

According to the present invention, image data is determined and classified into halftone dot areas, on-screen text areas, text areas and the other areas, and the image data of each area is output with an area separation signal that indicates its area type. The image data is subjected to a spatial filtering process with reference to the area separation signal. At this point, when the area separation signal indicates that the area is of an on-screen text area, it is possible to perform a different filtering process in accordance with the color space of the input image data. That is, a filtering process for sharpening is effected on an image that is represented in the RGB color space, whereas a filtering process for smoothening is effected on an image that is represented in the CMYK color space. As a result, it is possible to perform a suited process in accordance with the usage purpose of image data (e.g., either the image data is used for printing or used directly).

According to the present invention, when it is determined that on-screen text area does not include any character and a text edge is detected, the image data will be subjected to a different filtering process in accordance with the color space of the input image data. That is, it is possible to produce an improved effect on the characters on the halftone screen by performing a more suited process on on-screen text.

Here, in the present invention, “On-screen text area” means an area wherein text is included in a halftone dot area (that is, wherein text is superimposed on a halftone screen).

### BRIEF DESCRIPTION OF THE DRAWINGS

FIG. 1 is a sectional view showing an image processing apparatus (digital multifunctional machine) in the present embodiment;

FIG. 2 is a functional block diagram showing the overall configuration of an image processing apparatus in the present embodiment;

FIG. 3 is a diagram for illustrating the functional configuration of an image processing unit in the present embodiment;

FIG. 4 is a diagram for illustrating the functional configuration of an area separation processor in the present embodiment;

FIG. 5 is a diagram used for illustrating the operation of an area separation processor in the present embodiment;

FIG. 6 is a diagram used for illustrating the operation of an area separation processor in the present embodiment;

FIG. 7 is a diagram used for illustrating the operation of an area separation processor in the present embodiment;

FIG. 8 is a diagram used for illustrating the operation of an area separation processor in the present embodiment;

FIGS. 9A and 9B are diagrams used for illustrating the operation of an area separation processor in the present embodiment;

FIG. 10 is a diagram used for illustrating the functional configuration of a chromatic/achromatic determinator in the present embodiment;

FIG. 11 is a diagram used for illustrating the states of a text edge signal output in the present embodiment;

FIG. 12 is a diagram used for illustrating the states of an area separation signal output in the present embodiment; and,

FIG. 13 is a diagram used for illustrating filtering processes applied in the present embodiment.

### DESCRIPTION OF THE PREFERRED EMBODIMENTS

The best mode for carrying out the present invention will be described with reference to the accompanying drawings. Here, the present embodiment will be described taking an example in which an image processing apparatus of the present invention is applied to a digital multifunctional machine.

### [1. Apparatus Configuration]

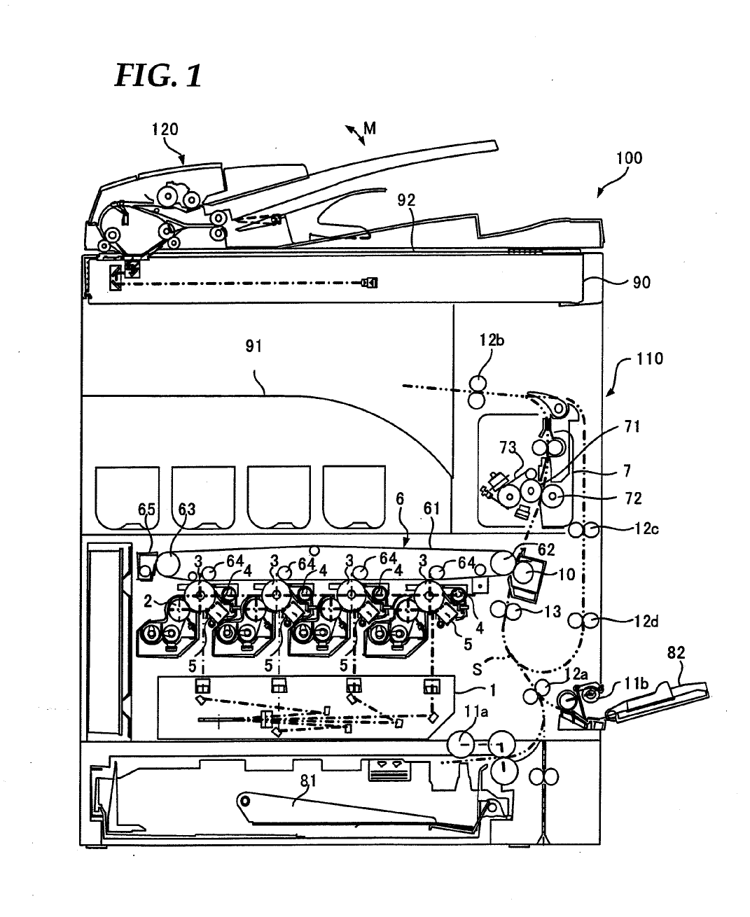

To being with, FIG. 1 is a diagram showing a configurational example of an image processing apparatus 100 to which the present is applied. Image processing apparatus 100 forms a multi-colored or monochrome image on a predetermined sheet (recording paper) in accordance with image data transmitted from the outside, and is composed of a main apparatus body 110 and an automatic document processor 120. Main apparatus body 110 includes: an exposure unit 1; developing units 2, photoreceptor drums 3, cleaning units 4, chargers 5, an intermediate transfer belt unit 6, a fixing unit 7, a paper feed cassette 81 and a paper output tray 91.

Arranged on top of main apparatus body 110 is a document table 92 made of a transparent glass plate on which a document is placed. On the top of document table 92, automatic document processor 120 is mounted.

Automatic document processor 120 automatically feeds documents onto document table 92. This document processor 120 is constructed so as to be pivotable in the bidirectional arrow M so that a document can be manually placed by opening the top of document table 92.

The image data handled in image processing apparatus 100 is data for color images of four colors, i.e., black (K), cyan (C), magenta (M) and yellow (Y). Accordingly, four developing units 2, four photoreceptor drums 3, four chargers 5, four cleaning units 4 are provided to produce four electrostatic latent images corresponding to black (K), cyan (C), magenta (M) and yellow (Y). That is, four imaging stations are constructed thereby.

Charger 5 is the charging device for uniformly electrifying the photoreceptor drum 3 surface at a predetermined potential. Other than the corona-discharge type chargers shown in FIG. 1, chargers of a contact roller type or brush type may also be used.

Exposure unit 1 corresponds to the image writing device of the present invention, and is constructed as a laser scanning unit (LSU) having a laser emitter, reflection mirrors, etc. In this exposure unit 1, a polygon mirror for scanning a laser beam, optical elements such as lenses and mirrors for leading the laser beam reflected off the polygon mirror to photoreceptor drums 3 are laid out. The specific configuration of the optical scanning unit that constitutes exposure unit 1 will be described later. As exposure unit 1, other methods using an array of light emitting elements such as an EL or LED writing head, for example may be used instead.

This exposure unit 1 has the function of illuminating the electrified photoreceptor drums 3 with light in accordance with the input image data to form electrostatic latent images corresponding to the image data on the surface of the photoreceptor drums.

Developing units 2 visualize the electrostatic latent images formed on photoreceptor drums 3 with four color (YMCK) toners.

Cleaning unit 4 removes and collects the toner left over on the photoreceptor drum 3 surface after development and image transfer.

Intermediate transfer belt unit 6 arranged over photoreceptor drums 3 is comprised of an intermediate transfer belt 61, an intermediate transfer belt drive roller 62, an intermediate transfer belt driven roller 63, four intermediate transfer rollers 64 corresponding to four YMCK colors and an intermediate transfer belt cleaning unit 65.

Intermediate transfer belt drive roller 62, intermediate transfer belt driven roller 63 and intermediate transfer rollers 64 support and tension intermediate transfer belt 61 to circulatively drive the belt. Each intermediate transfer roller 64 provides a transfer bias to transfer the toner image from photoreceptor drum 3 onto intermediate transfer belt 61.

Intermediate transfer belt 61 is arranged so as to be in contact with each photoreceptor drum 3. The toner images of different colors formed on photoreceptor drums 3 are sequentially transferred in layers to intermediate transfer belt 61, forming a color toner image (multi-color toner image) on intermediate transfer belt 61. This intermediate transfer belt 61 is an endless film of about 100 μm to 150 μm thick, for example.

Transfer of toner images from photoreceptor drums 3 to intermediate transfer belt 61 is performed by intermediate transfer rollers 64 that are in contact with the rear side of intermediate transfer belt 61. Each intermediate transfer roller 64 has a high-voltage transfer bias (high voltage of a polarity (+) opposite to the polarity (−) of the static charge on the toner) applied thereto in order to transfer the toner image. This intermediate transfer roller 64 is a roller that is formed of a base shaft made of metal (e.g., stainless steel) having a diameter of 8 to 10 mm and a conductive elastic material (e.g., EPDM (ethylene-propylene-dien rubber), foamed urethane or the like) coated on the shaft surface. This conductive elastic material enables uniform application of a high voltage to intermediate transfer belt 61. Though in the present embodiment, rollers are used as the transfer electrodes, brushes or the like can also be used instead.

The thus visualized electrostatic images of color toners on different photoreceptor drums 3 are laid over one after another on intermediate transfer belt 61. The laminated image information is transferred to the paper as intermediate transfer belt 61 rotates, by an aftermentioned transfer roller 10 that is arranged at the contact position between the paper and intermediate transfer belt 61.

In this process, intermediate transfer belt 61 and transfer roller 10 are pressed against each other forming a predetermined nip while a voltage for transferring the toner to the paper (a high voltage of a polarity (+) opposite to the polarity (−) of the static charge on the toner) is applied to transfer roller 10. Further, in order to constantly keep the above nip, either transfer roller 10 or intermediate transfer belt drive roller 62 is formed of a hard material (metal or the like) while the other is formed of a soft material such as an elastic roller or the like (elastic rubber roller, foamed resin roller etc.).

Since the remaining toner that has not been transferred to the paper by transfer roller 10 and remains on intermediate transfer belt 61 would cause color contamination of toners at the next operation, the toner is removed and collected by intermediate transfer belt cleaning unit 65. Intermediate transfer belt cleaning unit 65 includes, for example a cleaning blade as a cleaning member that is in contact with intermediate transfer belt 61. Intermediate transfer belt 61 is supported from its interior side by intermediate transfer belt driven roller 63, at the portion where this cleaning blade comes into contact with the belt.

Paper feed cassette 81 is a tray for stacking sheets (recording paper) to be used for image forming and is arranged under exposure unit 1 of main apparatus body 110. There is also a manual paper feed cassette 82 on which sheets for image forming can be set. Paper output tray 91 arranged in the upper part of main apparatus body 110 is a tray on which the printed sheets are collected facedown.

Main apparatus body 110 further includes a paper feed path S that extends approximately vertically to convey the sheet from paper feed cassette 81 or manual paper feed cassette 82 to paper output tray 91 by way of transfer roller 10 and fixing unit 7. Arranged along paper feed path S from paper feed cassette 81 or manual paper feed cassette 82 to paper output tray 91 are pickup rollers 11a and 11b, a plurality of feed rollers 12a to 12d, a registration roller 13, transfer roller 10, fixing unit 7 and the like.

Feed rollers 12a to 12d are small rollers for promoting and supporting conveyance of sheets and are arranged at different positions along paper feed path S. Pickup roller 11a is arranged near the end of paper feed cassette 81 so as to pick up the paper, one sheet at a time, from paper feed cassette 81 and deliver it to paper feed path S. Similarly, pickup roller 11b is arranged near the end of manual paper feed cassette 82 so as to pick up the paper, one sheet at a time, from manual paper feed cassette 82 and deliver it to paper feed path S.

Registration roller 13 temporarily suspends the sheet that is conveyed along paper feed path S. Then, the roller has the function of delivering the sheet toward transfer roller 10 at such a timing that the front end of the paper will meet the front end of the data area of the toner images on photoreceptor drums 3.

Fixing unit 7 includes a heat roller 71 and a pressing roller 72. Heat roller 71 and pressing roller 72 are arranged so as to rotate while nipping the sheet. This heater roller 71 is set at a predetermined fixing temperature by the controller in accordance with the signal from an unillustrated temperature detector, and has the function of heating and pressing the toner to the sheet in cooperation with pressing roller 72, so as to thermally fix the toner image transferred on the sheet, to the sheet by fusing, mixing and pressing the image of multiple color toners. The fixing unit further includes an external heating belt 73 for heating heat roller 71 from the outside.

Next, the sheet feed path will be described in detail. As stated above, the image processing apparatus has paper feed cassette 81 for storing sheets beforehand and manual paper feed cassette 82. In order to deliver sheets from these paper feed cassettes 81 and 82, pickup rollers 11a and 11b are arranged so as to lead the paper, one sheet at a time, to feed path S.

The sheet delivered from paper feed cassettes 81 or 82 is conveyed by feed rollers 12a on paper feed path S to registration roller 13, by which the paper is released toward transfer roller 10 at such a timing that the front end of the sheet meets the front end of the image information on intermediate transfer belt 61 so that the image information is transferred to the sheet. Thereafter, the sheet passes through fixing unit 7, whereby the unfixed toner on the sheet is fused by heat and fixed. Then the sheet is discharged through feed rollers 12b arranged downstream, onto paper output tray 91.

The paper feed path described above is that of the sheet for a one-sided printing request. In contrast, when a duplex printing request is given, the sheet with its one side printed passes through fixing unit 7 and is held at its rear end by the final feed roller 12b, then the feed roller 12b rotates in reverse so as to lead the sheet toward feed rollers 12c and 12d. Thereafter, the sheet passes through registration roller 13 and is printed on its rear side and discharged onto paper output tray 91.

### [2. Functional Configurations]

### [2.1 Overall Configuration]

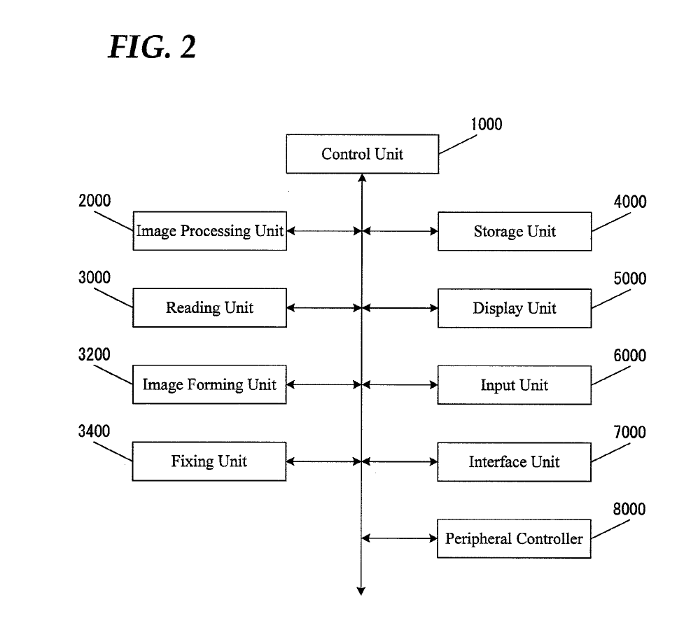

Next, the functional configurations of image processing apparatus 100 (FIG. 1) will be described with reference to FIG. 2. Image processing apparatus 100 includes a control unit 1000, to which an image processing unit 2000, an image forming unit 3200, a fixing unit 3400, a reading unit 3000, a storage unit 4000, a display unit 5000, an input unit 6000, an interface unit 7000 and a peripheral control unit 8000 are connected.

Control unit 1000 is a functional unit for controlling the whole of image processing apparatus 100. Control unit 1000 loads various programs stored in storage unit 4000 and executes the programs to realize diverse functions. The controller is formed of a CPU (Central Processing Unit) and the like, for example.

Image processing apparatus 100 is a multifunctional machine including a scanner, printer and peripheral devices, and has functions associated to a multifunctional machine. Specifically, image processing unit 2000 controls the associated functions, and converts the document images picked up by reading unit 3000 into pertinent electric signals to generate image data.

Reading unit 3000 is a functional unit that generates image data from a document by means of a CCD and the like. Image forming unit 3200 is a functional unit that develops the generated image data into a visual image with toner.

Fixing unit 3400 (fixing unit 7 in FIG. 1) is a functional unit that thermally fuses and fixes the toner image visualized by image forming unit 3200 onto printing paper. In this way, the image is formed by reading unit 3000, image forming unit 3200 and fixing unit 3400 under the control of image processing unit 2000.

Storage unit 4000 is a functional unit in which various kinds of programs, data, etc. necessary for operating image processing apparatus 100 are stored. For example, print commands given via the control panel (display unit 5000, input unit 6000) arranged on the top of image processing apparatus 100, detected information from unillustrated diverse sensors arranged at positions inside image processing apparatus 100, image information etc. input from external devices via interface unit 7000 are recorded.

Storage unit 4000 is formed of those ordinarily used in this art. As examples, semiconductor memory devices such as ROM (Read Only Memory) and RAM (Random Access Memory), magnetic disks such as hard disk drives (HDD) and the like can be considered.

Display unit 5000 is a functional unit for giving various kinds of information to the user and displaying the status of image processing apparatus 100. Display unit 5000 is formed of a display device such as a LCD, organic EL display or the like.

Input unit 6000 is a functional unit through which various kinds of control is input by the user, and is formed of, for example, control keys, a control panel and the like. Display unit 5000 and input unit 6000 may be integrally formed using a touch panel.

Interface unit 7000 is a functional unit for providing a network interface for connecting image processing apparatus 100 to a network and a USB interface for connection to external devices. Here, the external devices to be connected to interface unit 7000 may be electric and electronic devices that can form or acquire image information and are electrically connectable to image processing apparatus 100. Examples include a computer, digital camera, memory card and the like.

Peripheral control unit 8000 is a functional unit for controlling peripheral devices connected to image processing apparatus 100, for example, post-processing apparatuses such as a finisher, sorter, etc.

### [2.2 Configuration of Image Processing Unit]

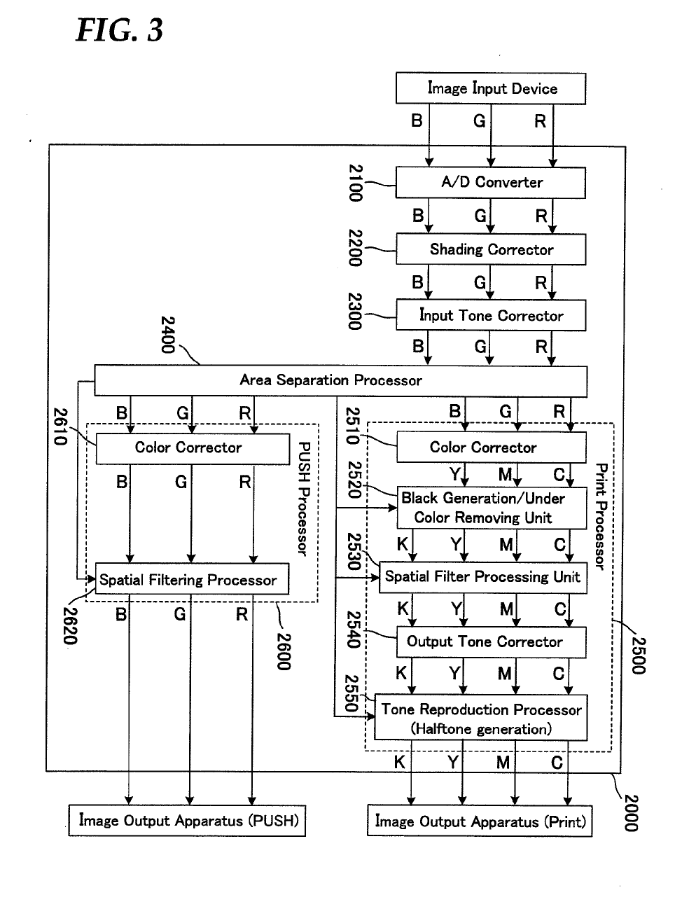

Now, image processing unit 2000 in the present embodiment will be described in detail with reference to FIG. 3. As shown in FIG. 3, image processing unit 2000 includes an A/D converter 2100, a shading corrector 2200, an input tone corrector 2300, an area separation processor 2400, a print processor 2500 and a PUSH processor 2600. Print processor 2500 includes a color corrector 2510, a black generation/under color removal unit 2520, a spatial filtering processor 2530, an output tone corrector 2540 and a (halftone generation) tone reproduction processor 2550. PUSH processor 2600 includes a color corrector 2610 and a spatial filtering processor 2620.

To begin with, based on the set details designated by the user through input unit 6000 (FIG. 2), RGB analog image signals read by an image input device (e.g., reading unit 3000) are converted into digital signals of CMYK (C: Cyan, M: Magenta, Y: Yellow, K: Black), which are output to image output device (e.g., image forming unit 3200).

First, as RGB analog signals are input to image processing unit 2000 from the image input device, the input signals are converted into digital RGB signals by A/D converter 2100. The digital RGB signals output from A/D converter 2100 are processed by shading corrector 2200, where various distortions generated by the illumination system, image forming system and imaging system of the image input device are removed from the digital signals.

Then, input tone corrector 2300 adjusts color balance of the RGB signals input from shading corrector 2200 and also performs a process of converting the density signal and other associated signals into signal forms that are adopted by the color image processing apparatus so as to be easily handled by the image processing system.

Next, the RGB signals output from input tone corrector 2300 are input to area separation processor 2400. Here, area separation processor 2400, based on the input RGB signals, separates the original images into text edge areas, halftone dot areas, high-density photographic areas and low-density photographic areas, for example. Hereinbelow, separation of an original image into text edge areas, halftone dot areas, high-density photographic areas and low-density photographic areas, for instance, will be called “area separation”.

The signals after area separation are output to print processor 2500 when used for printing or to PUSH processor 2600 when PUSH scan is performed (that is, a case where the input signal is stored as is as image data or the image data is transferred to another device and other cases).

Here, in the present embodiment, the color space output from area separation processor 2400 will produce signals in an RGB color space representation.

### [2.2.1 Print Processor]

Next, the process in print processor 2500 will be described.

First, the RGB signals output from area separation processor 2400 are input to color corrector 2510.

In order to realize faithful color reproduction, color corrector 2510 performs a process of removing the gray component based on the spectrum characteristics of CMY coloring materials including unnecessary absorptive components, to output three CMY signals after color correction. That is, the RGB color space is converted into the CMY(K) color space.

Subsequently, black generation/under color removal unit 2520 performs a black generation process that generates the black(K) signal from the three CMY color signals after color correction and a process that outputs new CMY signals by subtracting the black signal obtained by the black generation process from the original CMY signals. Thus, CMYK signals are produced.

The CMYK signals output from black generation/under color removal unit 2520 are input into spatial filtering processor 2530.

Spatial filtering processor 2530 performs a spatial filtering process on the image data represented in the CMYK color space signals, based on the area separation result by area separation processor 108, so as to prevent the output image from blurring and degrading in granularity by correcting spatial frequency characteristics.

Then, the CMYK signals output from spatial filtering processor 2530 are input to an output tone corrector 2540.

Output tone corrector 2540 performs an output tone correcting process on the input CMYK signals in which the signals are converted into dot area ratio values, which are the characteristic values for image forming unit 3200.

The CMYK signals output from output tone corrector 2540 is then input to tone reproduction processor 2550.

Tone reproduction processor 2550 separates the input CMYK signals into pixels and performs a tone reproduction process so as to enable reproduction of each tone. The CMYK signals output from tone reproduction processor 2550 are supplied to an image output device (e.g., image forming unit 3200) so as to be formed into images.

Incidentally, as a typical method for the black generation process executed at the aforementioned black generation/under color removal unit 2520, there is a black generating method using a skeleton black. This method will be shown hereinbelow.

Here, it is assumed that the input/output characteristic of the skeleton curve is given as y=f(x), UCR(Under Color Removal) ratio is given as α(0<α<1), the data supplied from color corrector 2510 to black generation/under color removal unit 2520 is C, M and Y, and data output from black generation/under color removal unit 2520 is C′, M′, Y′ and K′. With this, C′, M′, Y′ and K′ can be obtained as following equations:

$$\{ \begin{matrix}{K}^{′} = f \{ min ( C , M , Y ) \} \\ {C}^{′} = C - α {K}^{′} \\ {M}^{′} = M - α {K}^{′} \\ {Y}^{′} = Y - α {K}^{′}\end{matrix}$$

In order to particularly enhance reproducibility of black text, color text and text on a halftone screen, spatial filtering processor 2530 makes greater the amount of emphasis on the high-frequency components in the text edge areas that have been separated by area separation processor 2400, by the sharpening/emphasizing process in the spatial filtering process. Further, spatial filtering processor 2530 performs a low-pass filtering process on the areas that have been determined as halftone dot area, in order to remove input halftone dot components.

For the other areas, the spatial filtering processor can perform optimal processing on the areas that are unlikely to be determined as either halftones or text (including photographic areas and document background areas) by applying an adaptively mixing filter (a filter that smoothens high-frequency components to some extent and sharpens low-frequency components to some extent).

Tone reproduction processor 2550 performs a halftone process so as to be able to reproduce gradations with optimal screens in conformity with each of the area separation results.

### [2.2.2 PUSH Processor]

Next, PUSH processor 2600 will be described.

First, the RGB signals output from area separation processor 2400 are input into color corrector 2610.

In order to realize faithful color reproduction, color corrector 2610 performs a process of color correction and outputs RGB signals without performing color space conversion.

The RGB signals output from color corrector 2610 are input into spatial filtering processor 2620.

Spatial filtering processor 2620 performs a spatial filtering process on the image data of the input RGB signals, using digital filters based on the area separation result from area separation process 2400, to correct the spatial frequency characteristics and thereby reduce blurs and moiré in the output image. Then, the RGB signal (image data) is transmitted to the image output apparatus.

### [2.3 Area Separation Processor]

Now, the configuration of the aforementioned area separation processor 2400 will be described using the drawings.

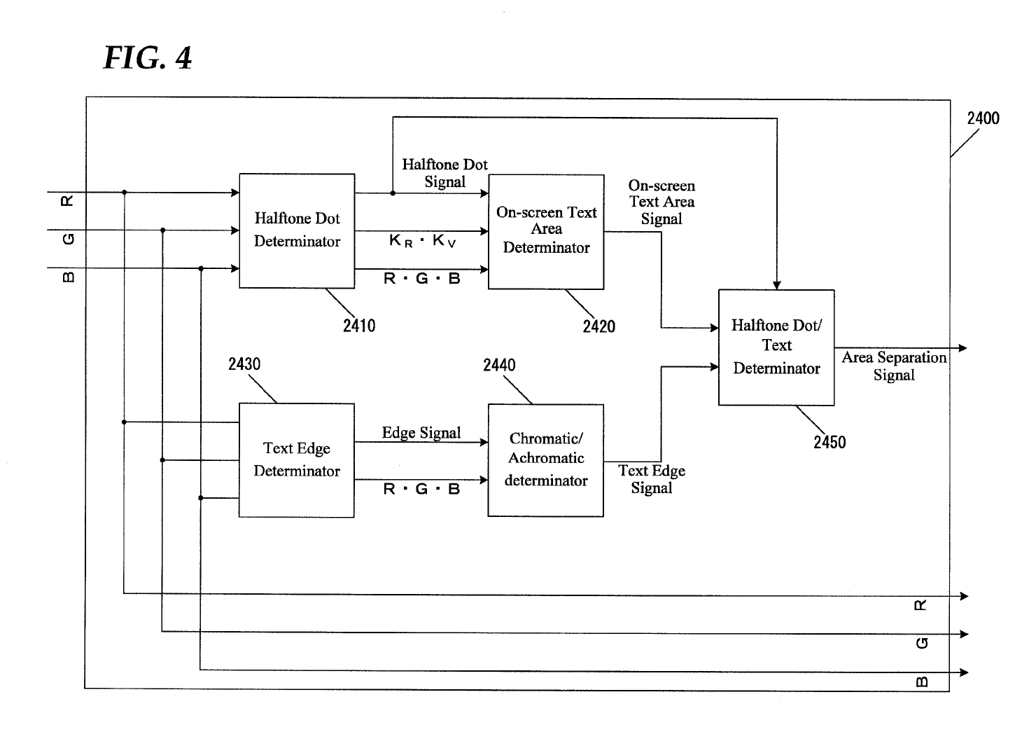

As shown in FIG. 4, area separation processor 2400 includes a halftone dot determinator 2410, an on-screen text area determinator 2420, a text edge determinator, a chromatic/achromatic determinator 2440 and a halftone dot/text determinator 2450. Here, area separation processor 2400 will output RGB signals as image data and area separation signals.

First, the input RGB signals are supplied to halftone dot determinator 2410 and text edge determinator 2430. Halftone dot determinator 2410 determines whether an observed pixel belongs to a halftone dot area, from the RGB signals.

Halftone dot determinator 2410 performs a process of determining a halftone dot area, using the features that a halftone dot area has “large variation in density within a small area” and a halftone dot area includes “dots having high density compared to the background”. The following steps 1 to 3 are performed within a block of M×N pixels (M and N are natural numbers) having an observed pixel at the center so as to determine whether the observed pixel belongs to a halftone dot area. This process is performed separately for each RGB color component, and if any observed pixel of the RGB colors is determined as a “halftone dot pixel”, “1” is output as a halftone dot signal. Otherwise, “0” is output.

Step 1: The average density value Dave of the nine pixels in the center of the block is determined, and each pixel in the block is binarized based on the average value. At this time, the maximum value Dmax and the minimum value Dmin are also determined.

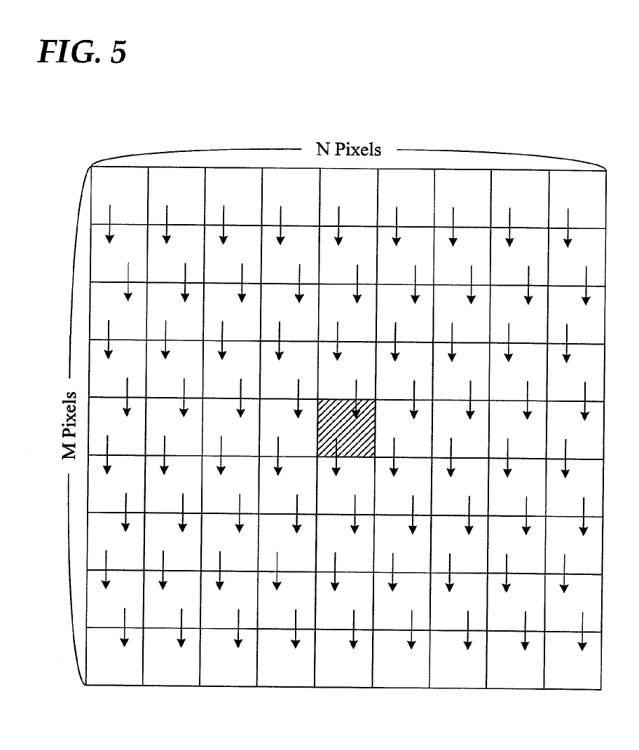

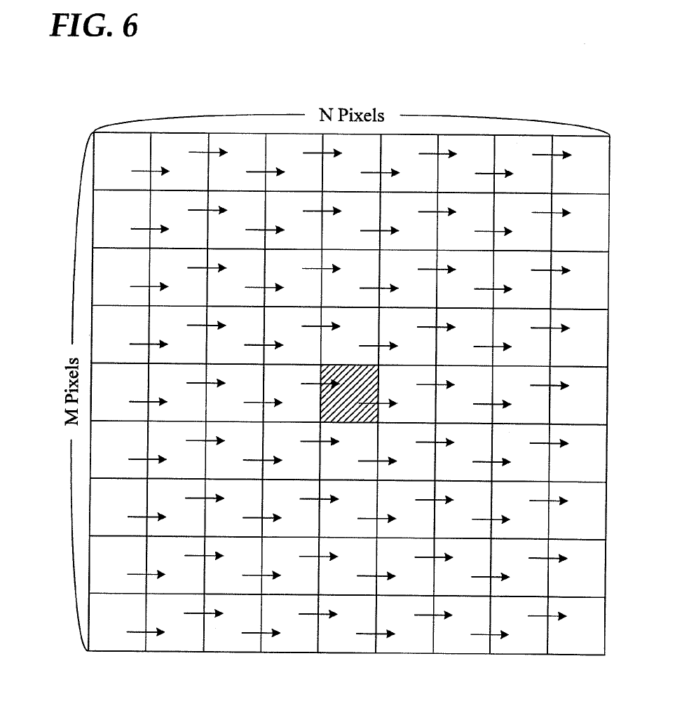

Step 2: The number of points at which the binarized data changes from “0” to “1” and the number of points from “1” to “0” are determined along the main scan direction (e.g., FIG. 5) and the sub scan direction (e.g., FIG. 6), respectively, and put as K_{R} and K_{V}. The present embodiment will be described taking the hatched area at the center in FIGS. 5 and 6 as the target pixel.

Step 3: When the value obtained by subtracting the average density value Dave from the maximum value Dmax is greater than a threshold B1 (Dmax−Dave>B1), the value obtained by subtracting the minimum value Dmin from the average density value Dave is greater than a threshold B2 (Dave−Dmin>B2), the number of transition points K_{R} is greater than a threshold T_{R} (K_{R}>T_{R}) and the number of transition points K_{V} is greater than a threshold T_{V} (K_{V}>T_{V}), the target pixel is determined as a “halftone dot pixel”. If the above conditions are not satisfied, the target pixel is determined as a “non-halftone dot pixel”. When a target pixel that is determined as not belonging to a halftone dot area and that is determined as not belonging to a text edge area at text edge determinator 2430 which will be described hereinbelow, the pixel is classified into the other area.

On-screen text area determinator 2420 (FIG. 4) receives K_{R}, K_{V} and a halftone dot signal together with the RGB signals, from halftone dot determinator 2410. Here, when the halftone dot signal is “1”, it is determined whether the area is an area in which any on-screen text exists, and an on-screen text area signal is output to halftone dot/text determinator 2450.

Here, on-screen text area determination is performed based on K_{R} and K_{V} input from halftone dot determinator 2410 and K₄₅ and K₁₃₅ obtained by the following steps 1 to 3.

Step 1: The average density value Dave of the nine pixels in the center of the block is determined, and each pixel in the block is binarized based on the average value. At this time, the maximum value Dmax and the minimum value Dmin are also determined.

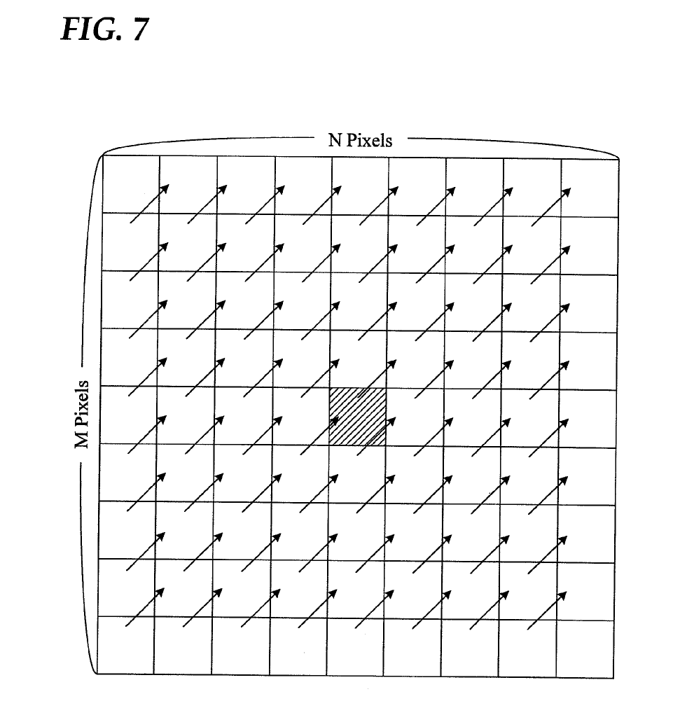

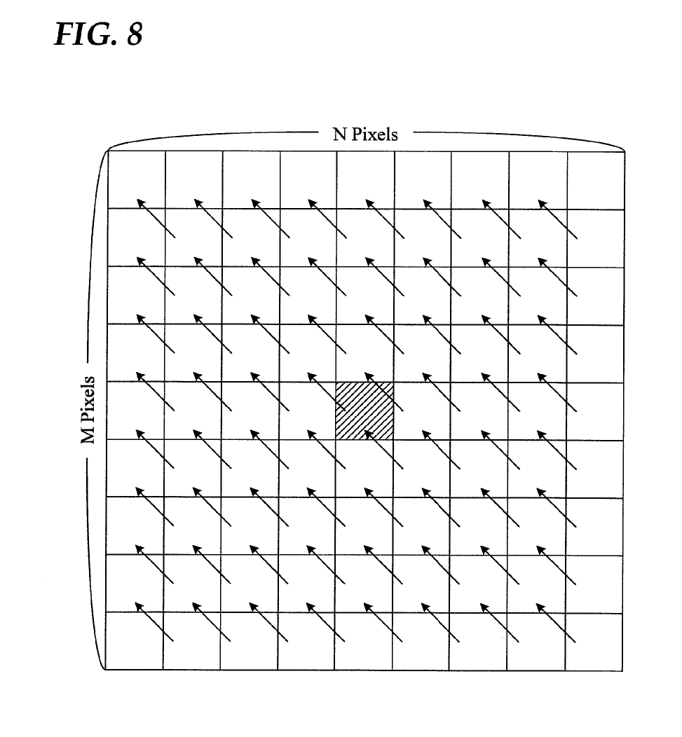

Step 2: The number of points at which the binarized data changes from “0” to “1” and the number of points from “1” to “0” are determined along the 45° direction and the 135° direction, for example as shown in FIGS. 7 and 8, and put as K₄₅ and K₁₃₅.

Step 3: Based on the fact that the numbers of transition points along the two orthogonal directions become different when a block of halftone dot area includes a text area, it is determined whether the observed halftone dot area is an on-screen text area, using the following equation:—

$$HT\_TEXT = \{ \begin{matrix}1 : & MAX ( \vert {K}_{R} - {K}_{V} \vert , \vert {K}_{45} - {K}_{135} \vert ) \geq TH\_HTtext \\ 0 : & Otherwise\end{matrix}$$

Here, if HT_TEXT is 1, the area is determined as an on-screen text area and “1” is output as the on-screen text area signal. If HT_TEXT is 0, the area is not determined as an on-screen text area and “0” is output as the on-screen text area signal. When the halftone dot signal from halftone dot determinator 2410 is “0”, on-screen text area signal “0” is output to halftone dot/text determinator 2450 without performing the above steps 1 to 3.

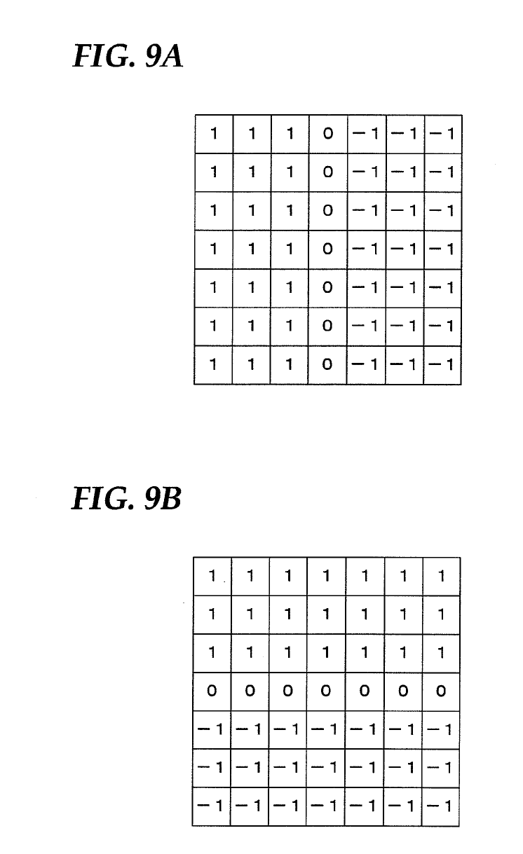

On the other hand, text edge determinator 2430 (FIG. 4) determines whether the observed pixel belongs to a text edge, from the RGB data. Specifically, determination as to whether the observed pixel belongs to a text edge is made using low-frequency edge detection filters shown in FIGS. 9A and 9B. If the pixel belongs to a text edge, “1” is output as the edge signal to chromatic/achromatic determinator 2440. Unless the pixel belongs to a text edge, “0” is output as the edge signal to chromatic/achromatic determinator 2440.

FIG. 9A shows filter coefficients Fila for calculation of the edge quantity Edge X in the main scan direction. Filter coefficients Fila are given as a 7×7 matrix. FIG. 9B shows filter coefficients Filb for calculation of the edge quantity Edge Y in the sub scan direction. Filter coefficients Filb are also given as a 7×7 matrix

Text edge determinator 2430 calculates a main scan direction edge quantity EdgeX(i,j) and sub scan direction edge quantity EdgeY(i,j) by convolving the observed pixel (i,j) as the target for determination as to G-data (Green data), with respective filer coefficients Fila and Filb.

EdgeX(i,j)=Mask(i,j)*Fila

EdgeY(i,j)=Mask(i,j)*Filb,

where Mask(i,j)={G(i+x, j+y)},
−3≦x≦3, −3≦y≦3, { } represents a set, G(i,j) is the G-value at pixel (i,j).

Next, text edge determinator 2430 compares the sum of average squares of edge quantity EdgeX(i,j) and EdgeY(i,j) with a threshold so as to determine whether the pixel belongs to the low-frequency edge.

That is, when the sum is equal to or greater than the threshold THedge(e.g., “450”), text edge determinator 2430 assigns 1 to Edge(i,j) and determines that the pixel belongs to an edge, and outputs “1”. On the other hand, when the sum is smaller than threshold THedge, text edge determinator 2430 assigns 0 to Edge(i,j) and determines that the pixel does not belong to an edge, and outputs “0”.

That is, Edge(i,j) is given as follow:

$$Edge ( i , j ) = \{ \begin{matrix}1 : & EdgeX ( i , j ) + EdgeY ( i , j ) \geq THedge \\ 0 : & Otherwise\end{matrix}$$

Chromatic/achromatic determinator 2440 (FIG. 4) receives the RGB signals and the edge signal from text edge determinator 2430. As receiving the edge signal, the chromatic/achromatic determinator determines whether the observed pixel is chromatic or achromatic, and outputs a text edge signal based on the determination result to halftone dot/text determinator 2450.

Halftone dot/text determinator 2450, based on the halftone dot signal supplied from halftone dot determinator, the on-screen text area signal supplied from on-screen text area determinator 2420 and the text edge signal supplied from chromatic/achromatic determinator 2440, outputs an area separation signal that indicates, halftone dot, normal text, on-screen text, or other area. Details will be described later.

### [2.4 Chromatic/Achromatic Determinator]

Now, the aforementioned chromatic/achromatic determinator 2440 will be described in detail using the drawings.

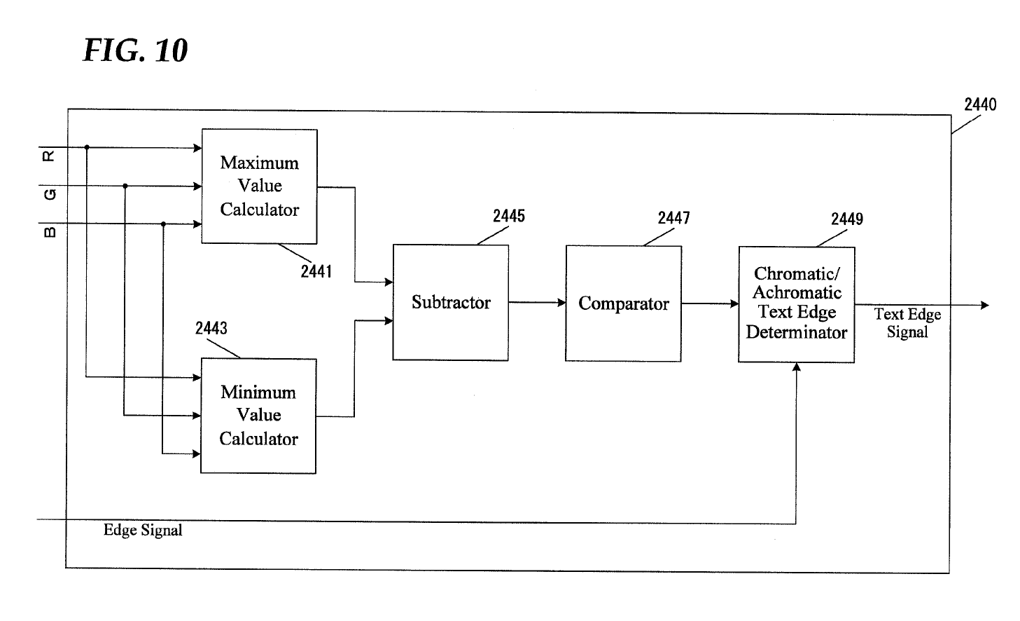

FIG. 10 is a diagram showing the functional configuration of chromatic/achromatic determinator 2440, including a maximum value calculator 2441, a minimum value calculator 2443, a subtractor 2445, a comparator 2447 and a chromatic/achromatic text edge determinator 2449.

Chromatic/achromatic determinator 2440 determines whether the observed pixel is chromatic or achromatic, and outputs “0”, which indicates achromatic text, if the edge signal from text edge determinator 2430 is “1” and a determination of “achromatic” is made, and outputs “1”, which indicates chromatic text if a determination of “chromatic” is made.

Further, if the edge signal from text edge determinator 2430 is “0”, “2”, which is a signal that indicates the other areas is output.

Specifically, the RGB signals are input to maximum value calculator 2441 and minimum value calculator 2443. Then, in maximum value calculator 2441 and minimum value calculator 2443, the maximum value and minimum value of the RGB signals of the observed pixel are determined (detected).

Next, the detected maximum value and minimum value are input to subtractor 2445, where the difference between the maximum value and the minimum value is determined. Subtractor 2445 outputs the difference to comparator 2447.

Comparator 2447 compares the given difference with a threshold TH_{c} and determines that the pixel is achromatic when the difference is equal to or lower than threshold TH_{c} and that the pixel is chromatic otherwise. That is, when the difference between R, G and B values at the observed pixel is small, the pixel is determined as being achromatic. Conversely, when the difference between R, G and B values at the observed pixel is large, the pixel is determined as being chromatic. The comparison result is output from comparator 2447 to chromatic/achromatic text edge determinator 2449.

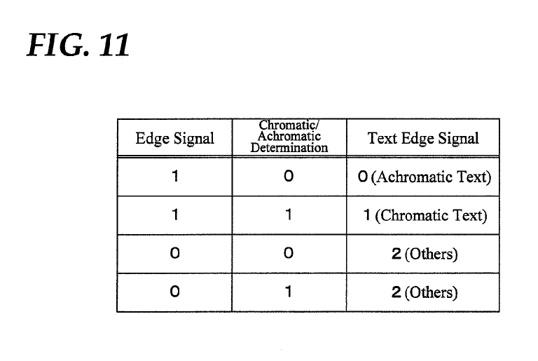

Based on the edge signal input from text edge determinator 2430 and the chromatic/achromatic comparison result input from comparator 2447, chromatic/achromatic text edge determinator 2449 outputs a text edge signal as shown in FIG. 11.

Here, FIG. 11 is a table that enables determination of the “text edge signal” based on the “edge signal” and “chromatic/achromatic determination”. Specifically,

the observed pixel is determined as achromatic text and “0” is output when the edge signal is “1” and the chromatic/achromatic determination is “0”;

the observed pixel is determined as chromatic text and “1” is output when the edge signal is “1” and the chromatic/achromatic determination is “1”;

the observed pixel is determined as the others and “2” is output when the edge signal is “0” and the chromatic/achromatic determination is “0”; and,

the observed pixel is determined as the others and “2” is output when the edge signal is “0” and the chromatic/achromatic determination is “1”.

### [2.5 Halftone Dot/Text Determinator]

Subsequently, halftone dot/text determinator 2450 (FIG. 4) will be described.

Halftone dot/text determinator 2450, based on the halftone dot signal from halftone dot determinator 2410, the on-screen text area signal from on-screen text area determinator 2420 and the text edge signal from chromatic/achromatic determinator 2440, generates area separation signal values of normal text (chromatic/achromatic), on-screen text (chromatic/achromatic), on-screen text (chromatic/achromatic) 2, halftone dot, and the others.

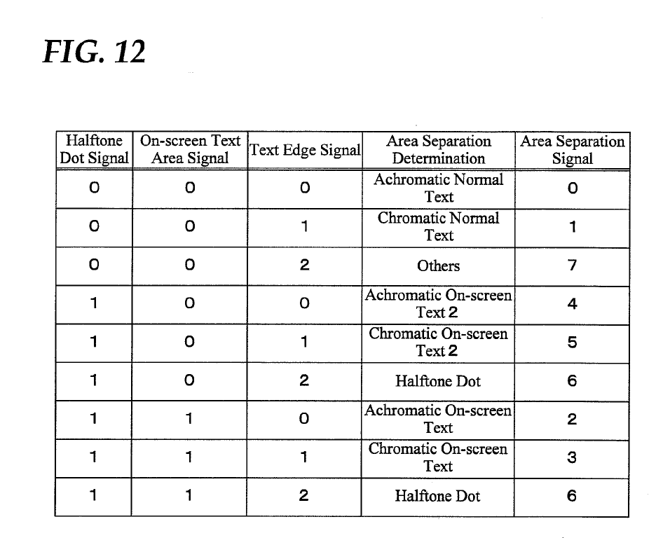

FIG. 12 shows a table to be used for this determination. As shown in FIG. 12, each area separation signal value (e.g., “0”) is stored in association with a halftone dot signal value (e.g., “0”), an on-screen text area signal value (e.g., “0”), a text edge signal value (e.g., “0”) and a state of the area separation determination (e.g., “achromatic normal text”).

Based on this table, the area separation signal is input to black generation/under color removal unit 2520, spatial filtering processor 2530, tone reproduction processor 2550 and spatial filtering processor 2620, located on the downstream of area separation processor 2400 in FIG. 3, whereby each functional unit can be operated to perform a suitable process in accordance with the area type.

In the conventional technology, only the area that is recognized as both a text edge and an on-screen text area are determined as on-screen text. Therefore, it is impossible to provide such a system that a narrower area can be detected as an on-screen text area by increasing the value of TH_HTtext in order to avoid an edge of a halftone dot photograph being taken as on-screen text while a greater area can be detected in a case of a scanning operation (PUSH copy).

In a copying (printing) process, if an edge of a halftone dot photograph is taken as on-screen text, especially as achromatic on-screen text, black generation is practiced, and the gap becomes conspicuous. On the other hand, in a scanning (PUSH copy) process, no black generation exists so that the gap will not become noticeable as much as that in a copying process.

Further, if a character on a halftone screen is not determined as on-screen text but is taken by mistake as a halftone dot area, the halftone dot area is smoothened, while the text area is emphasized, by the filtering process. This makes the gap noticeable. Accordingly, a preferable processing result can be obtained in a scanning (PUSH copy) process when a greater area is taken to be detected as on-screen text. On the other hand, in copying (printing), the amount of area detection of on-screen text is determined depending on which of the gap at the edge of a halftone dot photograph or the gap of on-screen text, priority is given to.

To deal with the above situation, in the present embodiment, not only in the case where both the text edge determination and the on-screen text area determination are made (that is, when the on-screen text area signal takes a value of “1” and the text edge signal takes a value of “0” or “1”), but also in the case where the text edge determination is made but no on-screen text area determination is made (that is, when the on-screen text area signal takes a value of “0” and the text edge signal takes a value of “0” or “1”), if the halftone dot signal has an output value of “1”, the case is classified as on-screen dot text determination 2. The cases other than this are determined as a halftone dot area.

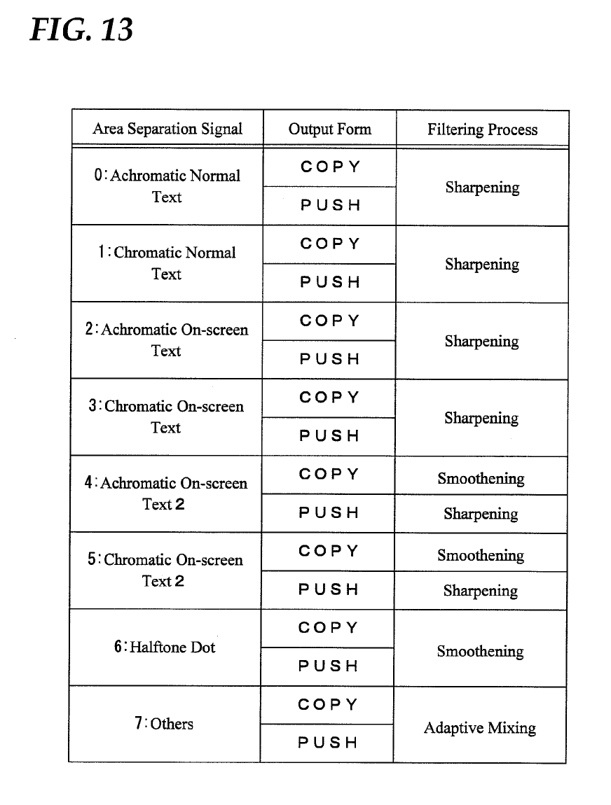

Under this condition, as shown in FIG. 13, the on-screen text signal (area separation signals 0 to 3) and the halftone dot signal (area separation signal 6) are subjected to the sharpening process (for area separation signals 0 to 3) and the smoothing process (for area separation signal 6), respectively, in both a copying (printing) operation and a scanning (PUSH copy) operation, as performed in the past. The on-screen text2 signal (area separation signals 4 and 5) is subjected to the same smoothing process as that for the halftone dot signal in a copying (printing) operation, whereas the signal is subjected to the same sharpening process as that for the on-screen text signal in a scanning (PUSH copy) operation. With this scheme, it is possible to improve reproducibility of on-screen text in a scanning (PUSH copy) operation while keeping the image quality as in the past in a copying (printing) operation.

In sum, in the present embodiment, the color space (CMYK) used for printing (COPY) and the color space (RGB) used for image data (PUSH) are made different. As a result, it is possible to perform more suited image forming and image output by using filtering processes in conformity with different color spaces.

Though the embodiment of the invention has been detailed heretofore with reference to the drawings, the specific configuration of the present invention should not be limited to the above embodiment, and various designs and variations without departing from the spirit and scope of the invention should be included in the scope of the following claims.

Further, the above embodiment was described taking an example in which the image processing apparatus is applied to an image forming apparatus. However, it goes without saying that the present invention can be also realized in electronic appliances including an image input device, image processing apparatus and image output apparatus (for example, a system in which a scanner and a printer are connected to a computer), and the like.

Moreover, in the present embodiment, each functional unit may be realized by software (programs). In this case, the same process is implemented by a program and stored in the storage. The controller loads and executes the programs so as to achieve actual processes by means of the functional units (hardware) in cooperation with the programs.

What is claimed is:

1. An image processing apparatus comprising:
an area separation processor that classifies image data into halftone dot areas, on-screen text areas, text areas and the other areas and outputs an area separation signal that indicates the area type of the area; and,
a spatial filtering processor that performs a spatial filtering process on the image data with reference to the area separation signal, characterized in that
the spatial filtering processor performs a different filtering process in accordance with the color space of the input image data when the area separation signal indicates that the area is an on-screen text area.

2. The image processing apparatus according to claim 1, wherein the area separation processor, includes:
an on-screen text area determinator which, when a target area is detected as a halftone dot area, determines whether the area includes a text; and,
a text edge determinator that determines whether the text edge is detected from the target area, and,
performs a process of outputting an area separation signal that indicates a halftone dot area or an on-screen text area, based on the result of determination at the on-screen text area determinator and the result of determination at the text edge determinator.

3. The image processing apparatus according to claim 2, wherein, when the on-screen text area determinator determines that the target area includes the text and the text edge determinator detects the text edge, the area separation processor determines that the target area is a first on-screen text area,
when the on-screen text area determinator determines that the target area includes no text and the text edge determinator detects the text edge, the area separation processor determines that the target area is a second on-screen text area, and,
the spatial filtering processor performs a different filtering process in accordance with the color space of the input image data when the area separation signal indicates that the target area is the second on-screen text area.

4. An image forming apparatus comprising:
an image input device that captures image data;
an image processor that processes the input image data; and
an image forming portion that forms an image from the image data that has been processed by the image processor, characterized in that the image processor is the image processing apparatus according to claim 1.

5. An image processing method comprising the steps of:
classifying image data into halftone dot areas, on-screen text areas, text areas and the other areas; and,
performing a spatial filtering process on each of the classified areas, characterized in that the spatial filtering process is implemented to perform a different filtering process in accordance with the color space of the input image data when the classified area is an on-screen text area.

6. A program that causes a computer to execute:
a step of classifying image data into halftone dot areas, on-screen text areas, text areas and the other areas;
a step of area separation processing for outputting an area separation signal that indicates the area type of the area;
a step of performing a spatial filtering process on the image data with reference to the area separation signal,
characterized in that the step of spatial filtering process is implemented to perform a different filtering process in accordance with the color space of the input image data when the area separation signal indicates that the area is an on-screen text area.
